(19) United States
(12) Patent Application Publication
(10) Pub. No.: US 2006/0028514 A1
(43) Pub. Date: Feb. 9, 2006

(54) Uninterrupted ink supply system for digital printers or "UISS"

(76) Inventors: Mario Balducci, Sterling, MA (US); Paolo Capano, Fagnano Olona (IT)

Correspondence Address: AGENCY SYSTEMS GROUP, 20 KILBUURN ROAD, STERLING, MA, 01564-2116, US

(21) Appl. No.: 10/911,174

(22) Filed: Aug. 4, 2004

(51) Int. Cl. B41J 2/17

(52) U.S. Cl. 347/84

(57) ABSTRACT

This invention consists of an ink tank that supplies printing fluids to digital printers and allows for uninterrupted printing, while delivering ink at stable or constant pressure so to insure high print quality. The tank's innovative design incorporates an In-feed or pressure stabilization chamber, a storage chamber and a supply chamber in a single molded unit.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK

Not Applicable

### BACKGROUND OF INVENTION

Traditionally, Digital Printers use a set of cartridges or pouches, filled with inks or dyes of various colors and characteristics, to supply the printing heads with the printing fluid needed to form a printed image.

The cartridges or pouches are generally self-contained and hold a relatively small amount of printing fluid. Once the printing fluid is exhausted, the cartridges or pouches need to be replaced. In most cases, this requires the printing process to stop until the cartridge is replaced, causing the print job underway to be damaged or aborted.

The use of finite ink cartridges, due to their limited capacity, does not allow for unattended printing, thereby limiting the productive capacity of most digital printers.

Another drawback when using the standard cartridges is the high cost of the printing fluid, which can run in the hundreds of dollars per liter. This translates into high printing costs. These costs can be drastically reduced by using printing fluids made by third-party manufacturers, as long as users are offered an easy and reliable way to load third-party inks on their digital printers.

Many digital print heads, however, require that ink be delivered with constant pressure in order to produce consistent quality prints. If pressure is not held constant, the resulting problems can vary from ink starvation (or poor media coverage) to bleeding (or excessive amount of ink being applied to the media). The solution is an ink delivery system that will deliver ink at constant pressure, independently of the quantity of ink present in the tanks (ink reservoirs).

### BRIEF SUMMARY OF THE INVENTION

This invention, the UISS, has been developed to give users of digital printing technology the means to achieve uninterrupted printing and the ability to select and use the printing fluid that best meets their needs, regardless of cost or manufacturer. To achieve these objectives, a way had to be devised so that ink could be delivered

The main component of the UISS is the ink tank, which, by virtue of its realization, functions as ink reservoir and constant pressure delivery mechanism, all enclosed in a single container. The ink tank is internally partitioned into three compartments: 1. Ink Storage (FIG. 2—“A”), 2. Pressure Stabilizer (FIG. 2—“B”), and 3. Ink Supply (FIG. 2—“C”). The compartments can differ in size and capacity, with the Ink Storage normally having the largest capacity.

The Ink Storage compartment is used to receive and hold ink, which is fed to the to the Ink Supply compartment through a small opening between the two compartments. Ink is drawn into the Supply compartment as it consumed in the printing process.

As ink in the Storage compartment is used up, it is replaced by air drawn from the Pressure Stabilizer through a small gap between the two compartments (FIG. 6). The Pressure Stabilizer allows ambient air pressure to be applied to the ink in the Ink Supply compartment. The Stabilizer gets its supply of ambient air through the Filling Orifice (FIG. 1—No. 1). In the event the Filling Orifice is fitted with a cover, such cover needs to have a small hole in it to allow passage of ambient air.

The Ink Tank container has two openings to the outside: 1. In-feed or Filling Orifice (FIG. 1—No. 1) and 2. The Out-feed or Delivery Orifice (FIG. 1—No. 2). The In-feed Orifice is generally larger in diameter and capacity than the Out-feed Orifice and is used to fill the ink tank, as needed, to supply ink to the Ink Supply compartment which, in turn, delivers ink to the digital printer to which it is connected. The Out-feed Orifice can be fitted with one or more connectors (FIG. 1—No. 2) designed to receive the tubing that delivers ink to the printer. The inside diameter of the Out-feed Orifice can vary, depending on the ink flow required in a particular application.

Due to the Ink Tank design, ink pressure at the Out-feed Orifice is determined by the air pressure in the Pressure Stabilizer. In turn, air pressure in the Pressure Stabilizer is determined by ambient air pressure (or atmospheric pressure) at the location where the UISS is installed. So the ink pressure at Out-feed Orifice is relatively stable and independent from the ink level in the Ink Storage compartment

The Ink Tank body comes with a round hole, which is positioned outside the ink reservoir area. This hole is used to mount the tank (or any number of tanks) on the UISS stand, by inserting a rigid, smooth rod of slightly smaller diameter into said hole. Once the desired number of tanks is mounted on the rod, the latter is itself mounted on the UISS stand to be placed in operation.

Once assembled, the UISS can be readied for normal operation by filling the tanks with ink and by connecting ink tubes between the out-feed connector (s) on the tank (s) and the digital printer, according to Brand and Model connection requirements.

### BRIEF DESCRIPTION OF THE SEVERAL VIEWS OF THE DRAWINGS

FIG. 1—Side view of Ink Tank (In-feed Orifice Cover not present)

FIG. 2—Mid-cross-sectional side view of Ink Tank

FIG. 3—Side View of Ink Tank, without cover, in the Filling Position

FIG. 4—Side View of Ink Tank, without cover, in the Filling Position

Note: First time Filling-no ink present in the Supply Chamber (FIG. 2—“C”)

FIG. 5—Side View of Ink Tank, without cover, in the Operating Position

Note: Supply Chamber is Full and Ink level is just above base of Pressure Stabilizer (FIG. 1—“B”)

FIG. 6—Side View of Ink Tank, without cover, in the Operating Position

Note: Ink is flowing out of The Out-feed Connector (FIG. 1—No. 2) and air is entering through the In-feed Chamber (FIG. 2—“B”) via the In-feed Orifice (FIG. 2—No. 1)

FIG. 7—Side view of Ink Tank molded components prior to being welded together

FIG. 8—Front View of Ink Tank in the filling position

### DETAILED DESCRIPTION OF THE INVENTION

The Uninterrupted Ink Supply System for Digital Printers, or “UISS” is made up by two major components: 1) The Ink Tank Assembly and 2) the Mounting Stand Assembly.

This invention is unique in that It makes it possible to achieve uninterrupted printing, bulk ink storage and ink pressure stability by using a single, seamless container. Here-to-fore similar functionality has only been achieved by using two or more containers, connected together in various fashions, but invariably more complex and prone to leakages and other failures.

The Ink Tank is constructed by welding together the Main Body to the Cover. Both parts are produced via injection molding technology. The molds are made out of stainless steel and are fabricated specifically for the purpose of generating the ink tank components. The design of the Cover incorporates a groove that accommodates the outer edges of the Main Body, so to facilitate a strong and continuous weld between the two parts. A continuous weld is an essential requirement in order for this invention to perform as claimed.

The plastic material used to construct the tank may vary, depending on the type of liquid that it is going to used in it. The plastic type is selected so is will not be affected in any way by the chemical composition of the fluid it will contain. HDPE and PPE are commonly used materials, but other materials can be used.

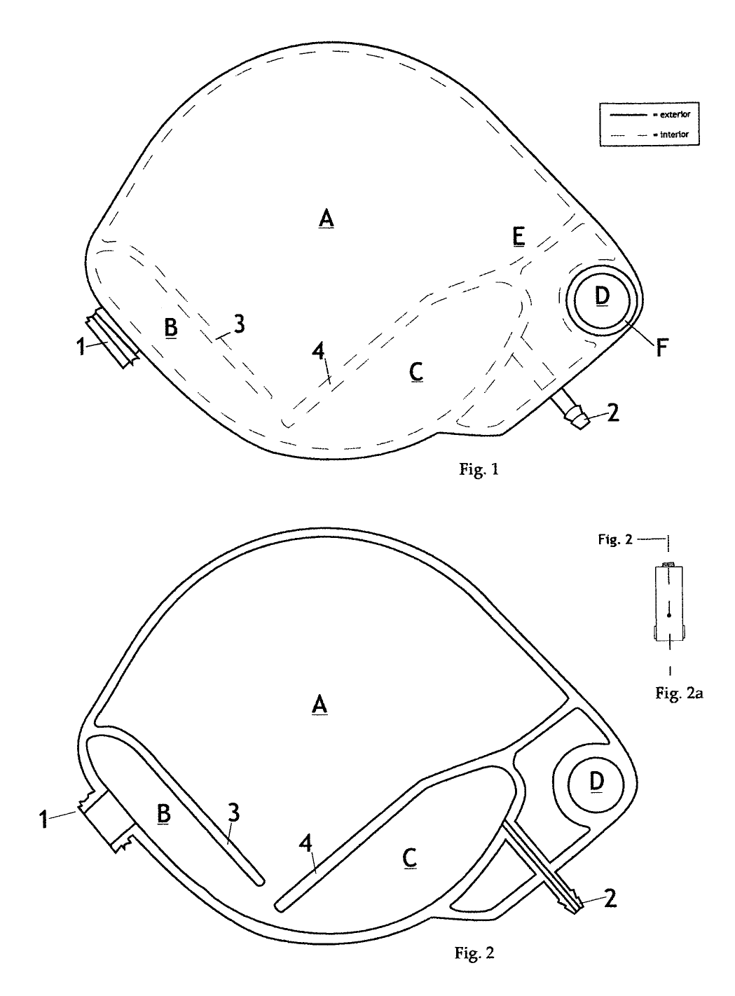

The Ink Tank, when fully assembled, has three internal chambers (see FIGS. 1 & 2) that are positioned in specific areas of the tank so that they can perform specific functions. These chambers, also called “Compartments”, are: A. Fluid Reservoir, B. Air Supply/Pressure Stabilizer and C. Ink Supply Chamber. The three chambers are partially separated by (2) partition walls that end at specific points inside the tank. In particular, one wall (FIG. 2—“3”) separates chamber B from Chamber A, while the other wall (FIG. 2—“4” on the drawings) separates Chamber A from Chamber B. The partition walls run perpendicular to each other for most of their length, and end at about ⅜″ from each other, with the end of wall No. 2 being lined-up with the edge of wall No. 3 that faces Chamber B.

The Ink Tank has two openings on the outside: 1. In-feed or Filling Orifice (FIG. 2—“3”) and 2. Out-feed Orifice or Supply Connector (FIG. 2—“4”). The In-feed Orifice is generally larger in diameter and capacity than the Out-feed Orifice and is used to fill the ink tank, as needed, to supply ink to the Ink Supply compartment which, in turn, delivers ink to the digital printer to which it is connected thorough the Out-feed Orifice.

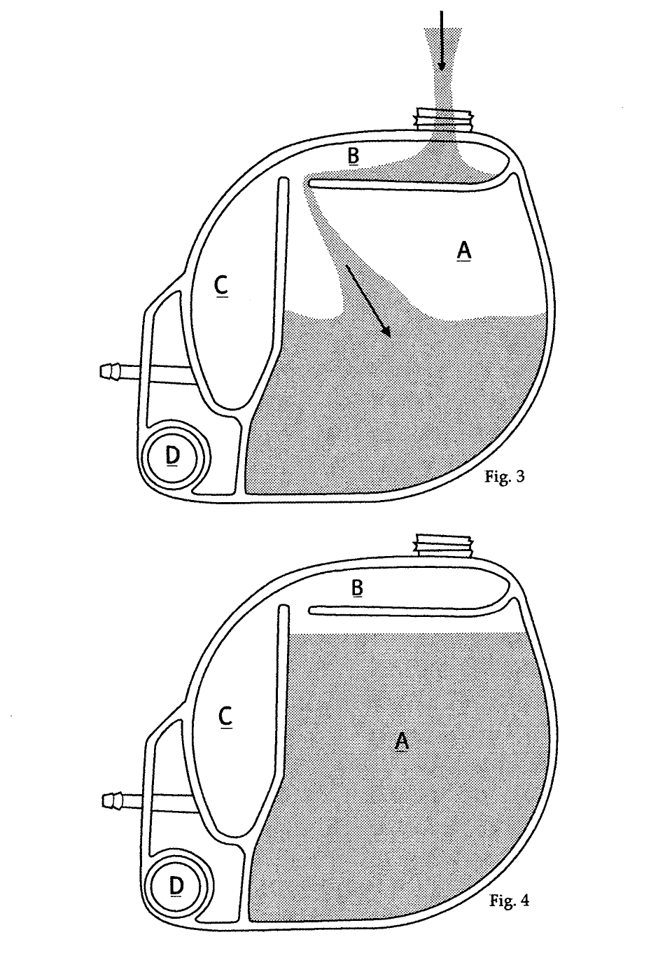

During the filling operation, the Ink Tank must be rotated to the filling position. In the filling position (FIG. 3) the Filling Orifice faces upwards so that fluid poured into the orifice will flow along Wall No. 3 and into Chamber A. Once the desired fluid level has been reached, the Ink Tank is rotated back to its operating position. In operating position the Out-feed Connector will face downward, perpendicular to the ground.

As the tank is rotated, ink will fill Chamber C and will flow up to a level that is slightly above the lower end of Wall 3. As long as sufficient ink is present in Chamber C ink will flow through connector No. 4 and printing can continue uninterrupted. The ink tank is designed to allow for uninterrupted printing, even during the filling operation, as long as the filling operation takes place while enough ink remains in Chamber C.

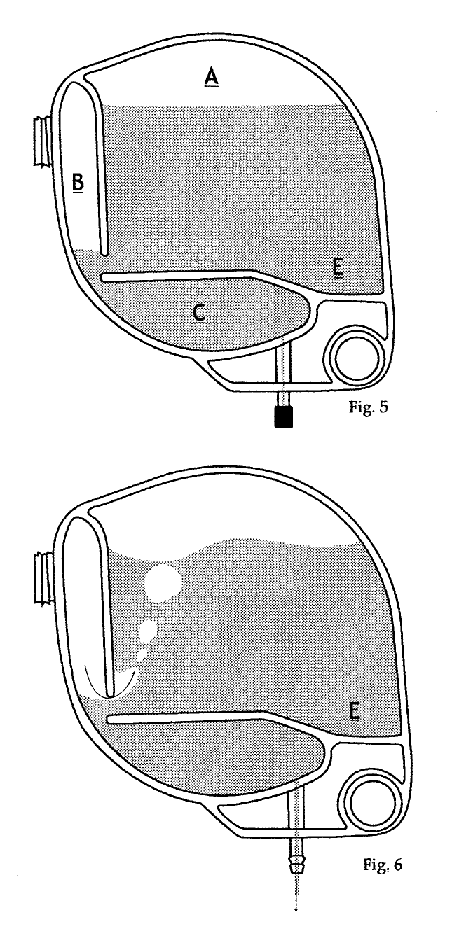

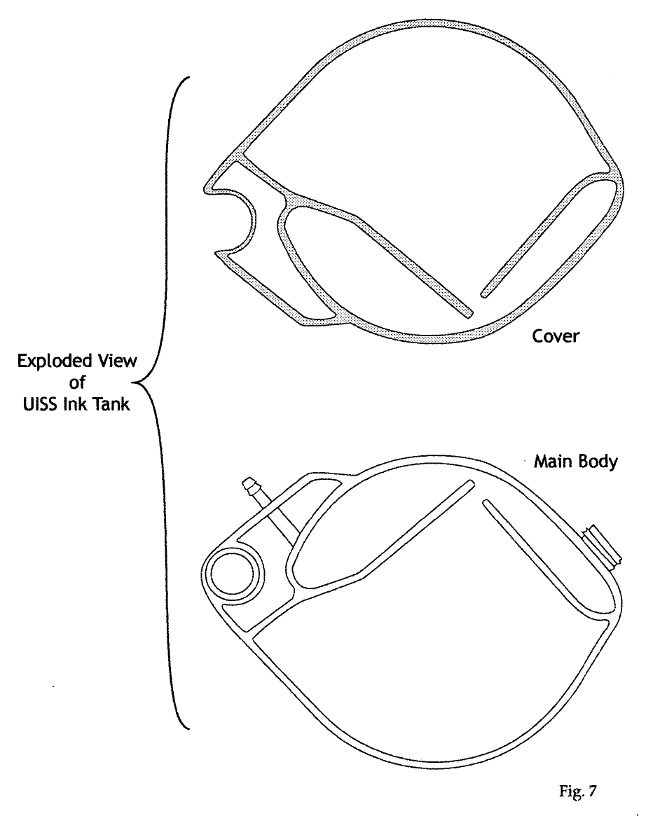

It is very important that the ink supply remain as pure and free from impurities as possible in order to prevent clogging and/or premature failure of the print heads. To help keep impurities out of the Out-feed a recessed area (FIG. 5“E”) has been included in the Storage Compartment, so that any impurities that fall out of suspension will, by gravity action, work their way toward to lower part of area “E” and remain there till the tank can be emptied and cleaned.

The Out-feed Orifice can be fitted with one or more connectors designed to receive the tubing that delivers ink to the printer. The inside diameter of the Out-feed Orifice can vary, depending on the ink flow required in a particular application.

The Ink Tank can be rotated tanks to the through-hole located at the end opposite the In-feed Orifice. This hole is obtained as part of the injection molding process and is the mounting hole used to install the tank on the UISS Stand.

A rigid mounting tube, inserted through the mounting hole and installed on the stand, holds the tank in place, either in the filling or operating positions.

Two stop rods, running parallel to the mounting tube are also installed on the UISS Stand to limit the rotation of the ink tank between the filling and the operating positions. In either position, due to the placement of the stop rods, the tank rests, without the need for additional restraints.

Claims of the invention are as follows:

1. An ink supply container for containing ink or other printing fluids, the ink supply container configured for providing ink or other printing fluids to an ink jet printing system, the ink container including:
A Fluid Reservoir or Ink Storage Chamber, an Air Supply & Pressure Stabilizer Chamber and an Ink Supply Chamber.

2. An ink supply container for containing ink as in claim 1, wherein the ink supply container is derived from a single plastic injection mold in two components: a. Main Body and b. Cover (see Fig.

3. An ink supply container for containing ink as in claim 2, wherein the container is assembled by welding the Main Body and the Cover together to form a sealed unit.

4. An ink supply container for containing ink as in claim 1, wherein the Fluid Reservoir (FIG. 2—“:A”), Air Supply & Pressure Stabilizer Chamber (FIG. 2—“B”) and Ink Supply Chamber (FIG. 2—“C”) are obtained by molding two partitioning walls (FIGS. 2—“3” & “4”) inside the container, so that said chambers communicate only through gaps at the end of such walls (see FIGS. 1 & 2).

5. An ink supply container for containing ink as in claim 1, wherein Ink or other printing fluid is introduced into the tank, when the tank is in the filling position, by way of an opening in the outer wall (FIG. 1—“1”) such opening being augmented by a threaded neck over which a similarly threaded cover can be applied, such cover having a small hole in its center to allow air to flow into the container as ink is used up. The opening or In-Feed Orifice being located near the top of the closed end of the Air Supply & Pressure Stabilizer Chamber.

6. An ink supply container for containing ink as in claim 5, wherein ambient air pressure is used to provide a stable flow of ink through the Out-feed Orifice via the Supply Connector (s).

7. An ink supply container for containing ink as in claim 1, wherein a recess (FIG. 5“E”) is built into the tank in such a way to allow for any heavy particulate or impurities that may be present in the tank and that can be deposited by gravity action, to accumulate therein and to be retained in such recession until such time at the tank can be emptied and flushed clean.

8. An ink supply container for containing ink as in claim 1, wherein a mounting hole (FIG. 1“D”) is molded on the side opposite to the In-feed Orifice (FIG. 1—“1”) which allows the ink tank to be installed on a stand and rotated between the filling position and the operating position.

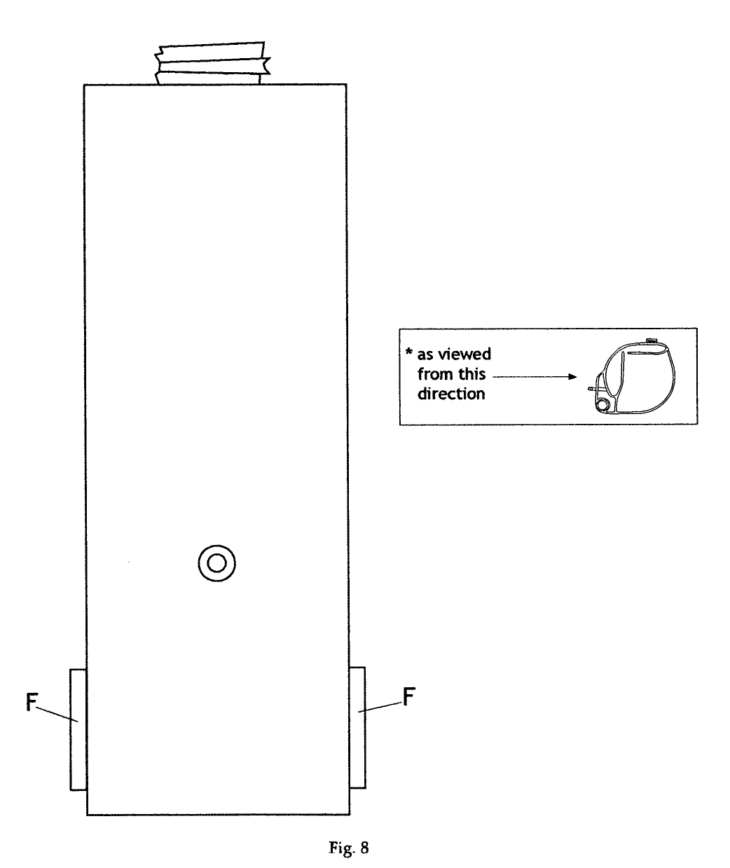

9. An ink supply container for containing ink as in claim 8, wherein a en extension of the mounting hole (FIG. 8—“F”) is provided on each side of the ink tank to maintain a space between two or more adjacent ink tanks when installed on the stand.

10. An ink supply container for containing ink as in claim 1, wherein the tank is used to contain and dispense any liquid, including printing fluids.

11. An ink supply container for containing ink as in claim 1, wherein any number of ink tanks can be used at any given time to supply any number of printing fluids and in any color, as the application may require.
